(19) United States
(12) Patent Application Publication
(10) Pub. No.: US 2016/0307124 A9
(43) Pub. Date: Oct. 20, 2016

(54) Method and System for Skill-Based Endorsement and Credential Validation Platform

(71) Applicant: Eyal Grayevsky, San Francisco, CA (US)

(72) Inventor: Eyal Grayevsky, San Francisco, CA (US)

(21) Appl. No.: 13/671,616

(22) Filed: Nov. 8, 2012

Related U.S. Application Data
(63) Continuation-in-part of application No. 13/625,669, filed on Sep. 24, 2012, now abandoned.
(60) Provisional application No. 61/673,926, filed on Jul. 20, 2012.

(51) Int. Cl. G06Q 10/06

(52) U.S. Cl. CPC G06Q 10/06

(57) ABSTRACT

System and method for evaluating the performance of at least one person (“applicant”) are provided. The applicant may select, at his or her discretion, people (“endorsers”) from an automated pre-populated list or manually entered list to request for endorsements or recommendations. This system and method allows the applicant to capture endorsements more efficiently and effectively.

### INCORPORATION BY REFERENCE

This application is a continuation-in-part of U.S. non-provisional application No. 13,625,669 filed on Sep. 24, 2012, which claims the benefit of priority under 35 U.S.C. 119(e) to the filing date of U.S. provisional patent application No. 61/673,926 “Skill-Based Endorsement System” which was filed on Jul. 20, 2012, and which are incorporated herein by reference in its entirety.

### FIELD OF THE INVENTION

The present invention relates generally to automating the endorsement or recommendation system, and more specifically, an improved system and method to request, accept, store, and retrieve recommendations and endorsements from endorsers solicited by the endorsee and facilitate communication between the endorser, the endorsee, and interested third parties. More specifically, the present invention's automated endorsement system operates in the field and context of job search.

### BACKGROUND OF INVENTION

The job searching process can be a complex and time sensitive endeavor with an unpredictable outcome. Furthermore, as the number of applicants exceeds the number of positions, the application and the selection process is also extremely competitive. Often job applicants are required to prepare and submit a resume, writing samples, references, as well as letters of recommendation.

As a result, the process of applying for a job is often a time consuming and stressful process for prospective job applicants. Unfortunately, given the above-identified factors, many applicants feel overwhelmed and perhaps even poorly informed about the application and selection process. Accordingly, a need therefore exists for improvements in the process of applying for a job. In particular, improvements that offer time-savings and reduce applicant anxiety are highly desirable.

Traditionally, a resume has been the main initial means of communication between a job applicant and a prospective hiring party. Originally, a resume was prepared on paper and submitted by hand to the prospective hiring party, by mail to a placement agency, or directly to the human resource department of a company. The rise in computer use led to the sending and acceptance of resumes via email or via other electronic means of communication.

Like the use of electronic means of sending, storing, and receiving resumes, other submissions as part of the application package have also evolved. However, although technology surrounding the writing and dissemination of the application package has advanced, the traditional text based format has not. For example, traditional letters of recommendation require the person writing the recommendation letter, or the endorser, to write a letter from scratch—such a tedious and time-consuming task that it creates friction in the process of obtaining those endorsements for the job applicant.

Furthermore, employers and recruiters may receive hundreds or thousands of responses to a job opening over a period of time. Each application package, therefore, can only be reviewed briefly. A short recommendation letter may likely be read in its entirety but important information may likely be left off the letter. The information of interest to a hiring party may be difficult to find or may be misleading due to the brevity. Even a long recommendation letter, which may contain more key information, would most likely not be read in its entirety and still may not contain all the potential key information that the prospective hiring party desires to know. Furthermore, a long recommendation letter, which may contain more key information, would still require unnecessary time and effort by the hiring party to sift through the writing and locate strengths and values that are relevant to the position being filled.

The recommendation letter format itself is a problem. The applicant usually must determine and locate the desired people suitable for providing their recommendation or endorsement, such as managers, colleagues, professors, or classmates. Next, the applicant must request the recommendation letters from them—this is no easy task. The applicant must request the recommendation or endorsement in timely manner. The applicant must give the people providing the recommendation or the endorsement (“endorser”) enough time to prepare and provide the recommendation. Unfortunately, however, this may not always be possible, as people sometimes may need to change or seek jobs unexpectedly. Furthermore, endorsers may decline to provide their recommendation or endorsement for a variety of reasons—both professional and/or personal. For example, the endorser may decline to provide their recommendation because they simply do not have the time to write a recommendation for the applicant at the time of applicant's request or within the time frame requested by the applicant. Furthermore, a potential endorser may refuse to provide a job applicant with a recommendation due to the difficult nature of having to execute the recommendation in the form of a written letter. Thus, a need exists for a system that allows an endorser to provide a recommendation in a format that is quick and easy to execute but still accurately depicts the strengths and values of the job applicant.

To complicate matters further, the applicants may also need to match endorsers and their recommendation with the corresponding target employment position they are seeking. For example, an applicant may prefer a professor's recommendation in applying for a teaching position at a university. Furthermore, the applicant may want to seek a job-specific recommendation letter from specific endorsers so as to have the recommendation letter carry more weight. For example, a specific recommendation for a position from an employee of the corporation for which the applicant is seeking employment would carry more weight than a generic recommendation letter. Unfortunately, seeking only specific recommendations from relevant endorsers would limit the number of recommendations available to the applicant in the applicant's job search. Thus, there is a need to standardize the recommendation format to make any recommendations from any endorser applicable to any position.

The applicant may simply seek a generic recommendation letter from the endorser so as to be able to use the recommendation letter for as many jobs as possible. Unfortunately, seeking a generic recommendation letter also has its drawbacks. The recommendation letter may not carry as much weight, as it is not tailored for a specific job or employment position. The endorser may also refuse to write a recommendation letter that is generic and may be used for various employment positions, as the endorser may not be comfortable with such liberal use of his or her recommendation. Therefore, a need exists for a system that allows the job applicant to seek and collect recommendations from endorsers that may be suitable for use for both specific and generic job or employment positions. A need also exists for the applicant to keep a record of the recommendation for use at another time.

More specifically, a need exists for a format that allows a job seeker to provide more information regarding their qualifications and credentials to a prospective hiring party. A need exists for job applicants to present their credentials to a prospective hiring party in a format and presentation that goes beyond traditional methods to provide a broader, more complete view of the applicant's abilities while making it easier to evaluate. A need also exists for prospective hiring parties to access this additional information about applicants, allowing far more insight and depth to adequately match available positions, without sacrificing time and money.

Therefore, it is desirable to have a system and method that is more focused on the needs of a hiring party while enhancing accuracy, enhancing efficiency, and minimizing the high costs required through other existing methods. The present invention disclosed herein allows job seekers to capture a large amount of endorsements quickly and easily, by reducing the time and effort required by the endorser to perform the recommendation. They simply have to choose a set of skills and personality traits from a pre-populated list as opposed to having to actively write an elaborate letter of recommendation.

### OBJECTIVE OF THE INVENTION

Accordingly, it is an object of the present invention to provide a system and method for one person evaluating the performance of at least another person, such as a job applicant.

It is also an object of the invention to facilitate the exchange of evaluation of at least one person, such as a job applicant, with endorsement or recommendation through electronic means of communication.

It is also an object of the invention to provide a portal for facilitating interaction between job applicants, prospective hiring parties, and any potential interested third parties in an efficient and effective way.

It is also an object of the invention to allow users, for example job applicants, to provide as much comprehensive information as possible to interested prospective hiring parties.

It is also an object of the invention to allow prospective hiring party to retrieve and obtain as much potential job applicant information as possible in the more efficient way.

It is also an object of the invention to allow endorsers to provide for job applicants endorsements or recommendations for applicants in search of employment in a simple and time saving way.

It is also an object of the invention to allow endorsers to verify or validate the degree or work experience of the job applicant.

It is also an object of the invention to facilitate the request, acceptance, storage, and retrieval of recommendations and endorsements from one person, such as the endorser, solicited by the other, such as the job applicant.

It is also an object of the invention to facilitate communication between the applicant, the endorser, and any potential interested third parties.

It is also an object of the invention to provide the most updated information about the applicant for prospective hiring parties.

It is also an object of the invention to allow the job applicants with the ability to request endorsements or recommendation in another language that can be translated into English and vice versa.

It is also an object of the invention to allow the endorsers with the ability to provide endorsements or recommendation in another language that can be translated into English and vice versa.

It is also an object of the invention to allow the prospective hiring party with the ability to retrieve and view endorsements or recommendation in another language that can be translated into English and vice versa.

It is also an object of the invention to allow the applicants to organize the endorsements or recommendations through keeping track of the requests, checking on the status of the endorsements or recommendations, and maintaining a database of such endorsements or recommendations.

It is also an object of the invention to allow the hiring party to compile a list of skills desired for an applicant, whereby the hiring party may select the more important or desired skills in an applicant.

It is also an object of the invention to allow the most qualified applicant—that is the applicant with the most desired-for skills—to be matched and presented to the hiring party based on the hiring party's list of desired skills in an applicant for that particular employment position.

It is also an object of the invention to allow the applicants' endorser list to be automatically populated by taking advantage of their social network, such as Facebook or LinkedIn account.

These and other advantages and features of the present invention are described herein with specificity so as to make the present invention understandable to one of ordinary skill in the art.

### SUMMARY OF THE INVENTION

In one aspect, the present invention discloses a method to facilitate an interaction platform for skill-based endorsement comprising of providing a network; providing a host computer system wherein the host computer is connected to the network wherein the host computer provides a platform for one or more skill-based endorsement endorser to provide one or more skill-based endorsement to one or more skill-based endorsement endorsee; having the skill-based endorsement endorsee to import his or her contacts from external sources into the platform; further having the skill-based endorsement endorsee initiates endorsement request to his contact via the platform; wherein the skill-based endorser responds to the request by providing one or more endorsements via the platform.

In one embodiment, the platform is comprised of an analytical module wherein the module analyzes data comprising endorser activities, endorsee activities and endorsement activities. In one embodiment, the endorsee further initiates endorsement request based on the data analysis of the module. In one embodiment, the platform further comprises an endorsee profile wherein the endorsee's profile comprises the endorsements endorsed by the endorser. In one embodiment, the endorsee profile is available for viewing by the public. In one embodiment, the endorsee profile is available for viewing by a specific user wherein the specific user is determined by the endorsee. In one embodiment, the platform is further comprised of a pre-determined list of endorsements wherein the endorser provides the endorsement by selecting one of the pre-determined endorsements from the list.

In one other embodiment, the endorsee is a job applicant. In one embodiment, the public is comprised of one or more hiring parties. In one embodiment, the endorsements are arranged on the endorsee profile based on a pre-determined algorithm. In one embodiment, the pre-determined algorithm lists endorsements from top to bottom based on vouch frequency. In another embodiment, the skill-based endorsement endorser endorses a skill that is related to a certain job field.

In one embodiment, the platform is comprised of a relevancy module wherein said endorsement is selected from a recommendation list generated by said relevancy module wherein said relevancy module generates said recommendation list based on skills said skill-based endorsement endorsee claims in his professional profile. In another embodiment, the platform is comprised of a relevancy module wherein said endorsement is selected from a recommendation list generated by said relevancy module wherein said relevancy module generates said recommendation list based on skills that have been most frequently vouched for by other skill-based endorsement endorser. In another embodiment, the platform is comprised of a relevancy module wherein said endorsement is selected from a recommendation list generated by said relevancy module wherein said relevancy module generates said recommendation list based on a set of skills that are relevant to said skill-based endorsement endorser's specific education and employment history.

In another aspect of the invention, a system to host an interaction platform for skill-based endorsement disclosed which is comprised of a network; a host computer system wherein the host computer is connected to the network wherein the host computer provides a platform for one or more skill-based endorsement endorser to provide one or more skill-based endorsement to one or more skill-based endorsement endorsee; wherein the skill-based endorsement endorsee imports his or her contacts from external sources into the platform, wherein skill-based endorsement endorsee initiates endorsement request to his contacts via the platform, wherein the skill-based endorsement endorser responds to the request by providing one or more endorsements via the platform.

In one embodiment, the platform is comprised of an analytical module wherein the module analyzes data comprising endorser activities, endorsee activities and endorsement activities. In one embodiment, the endorsee further initiates endorsement request based on the data analysis of the module.

In one embodiment, the platform further comprises an endorsee profile wherein the endorsee's profile comprises endorsements. In one embodiment, the endorsee profile is available to the public for viewing. In one embodiment, the endorsee profile is available only to specific users for viewing wherein the specific user is determined by the endorsee. In one embodiment, the public is comprised of one or more hiring parties.

In one embodiment, the platform is further comprised of a pre-determined list of endorsements wherein the endorser provides the endorsement by selecting one of the pre-determined endorsements from the list. In one embodiment, the endorsee is a job applicant. In one embodiment, the endorsements are arranged on the endorsee profile based on a pre-determined algorithm. In one embodiment, the pre-determined algorithm lists endorsements from top to bottom based on vouch frequency. In one embodiment, the skill-based endorsement endorser endorses a skill that is related to a specific job field.

In another aspect of the invention, disclosed is a system to host an interaction platform for users comprising a network; a host computer; wherein the host computer is connected to the network wherein the host computer provides a job placement platform for one or more users to interact for the purpose of job placement wherein the users are comprised of at least one job seeking user, at least one job provider user, and at least one third party skill-based endorsement provider, a skill endorsement request module allowing the job seeking user to request skill-based endorsement from the third party skill-based endorsement provider and allowing the third party skill-based endorsement provider to provide a skill-based endorsement to the job seeking user, a viewing module wherein the job provider user can view the job seeking user's skill-based endorsements in deciding whether to hire the job seeker.

In one embodiment, the job placement platform is further comprised of an analytical module wherein the module analyzes data comprising the job seeking user activities, the job provider user activities and the third party skill-based endorsement provider activities. In one embodiment, the job seeking user initiates further skill-based endorsement request based on data analysis of the analytical module.

In one embodiment, the job seeking user can select which job provider can view the job seeking user's skill-based endorsement. In one embodiment, the endorsee profile is available only to specific users for viewing wherein the specific user is determined by the endorsee. In one embodiment, the skill endorsement request module is further comprised of a validation module wherein the validation module allows the job seeking user to request a credential validation from the third party skill-based endorsement provider and allowing the third party skill-based endorsement provider to provide the credential validation to the job seeking user wherein the viewing module allows the job provider user to view the job seeking user's credential validation in deciding whether to hire the job seeker. In one embodiment, the credential validation module is further comprised of a validation relevancy module wherein the validation relevancy module generates a recommended list of credential validation requests to the third party skill-based endorsement provider based on the credential of the Job seeking user and the credential's nexus to the third party skill-based endorsement provider.

In another embodiment, the credential is comprised both academic and professional credentials. So for example, if the third party skill-based endorsement provider's association with the job seeking user is based on a “professor to student” association, then the validation relevancy module will automatically generate credential validation requests as to the job seeking user's educational degree.

In another aspect of the invention, a system to host an interaction platform for users comprising a network; a host computer; wherein the host computer is connected to the network wherein the host computer provides a job placement platform for one or more users to interact for the purpose of job placement wherein the users are comprised of at least one job seeking user, at least one job provider user, and at least one third party credential validation provider, a credential validation module allowing the job seeking user to request credential validation from the third party credential validation provider and allowing the third party credential validation provider to provide a credential validation to the job seeking user, a viewing module wherein the job provider user can view the job seeking user's credential validation in deciding whether to hire the job seeker. In one embodiment the job placement platform is further comprised of an analytical module wherein the module analyzes data comprising the job seeking user activities, the job provider user activities and the third party credential validation provider activities.

In one embodiment, the job seeking user initiates further credential validation request based on data analysis of the analytical module. In one embodiment the job seeking user can select which job provider can view the job seeking credential validation.

In one embodiment the skill a credential validation module is further comprised of a validation relevancy module wherein the validation relevancy module generates a recommended list of credential validation requests third party credential validation provider based on the profile of the job seeking user. In one embodiment, the credential validation module is further comprised of a validation relevancy module wherein the validation relevancy module generates a recommended list of credential validation requests to the third party credential validation provider based on the credential of the Job seeking user and the credential's nexus to the third party credential validation provider. In another embodiment, the credential is comprised both academic and professional credentials.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a schematic flowchart illustrating the applicant's options of sending an endorsement or vouch request to potential endorsers or viewing vouched skills compiled from the complete endorsements or recommendations from endorsers.

FIG. 2 is a schematic flowchart illustrating the process of sending an endorsement or recommendation request from the applicants to the potential endorsers.

FIG. 3 is a schematic flowchart illustrating the process of responding to the endorsement or recommendation request, wherein the endorsers have the option of either accepting or declining to provide the endorsement or recommendation.

FIG. 4 is a schematic flowchart illustrating the process viewing the endorsements or recommendations for the applicant by either the applicant him or herself or by the hiring party.

FIG. 5 is a schematic screenshot of an embodiment of the send list that is pre-populated with the information that is extrapolated from the applicant's social network such as Facebook, LinkedIn, or other similar accounts.

FIG. 6 is a schematic screenshot of an embodiment of the endorser's vouches form, wherein the endorser can select from a list of hard skills, soft skills, or personality traits, and also provide an optional written description to support the selection.

FIG. 7 is a schematic screenshot of an embodiment of the applicant's vouches, wherein the applicant can view the number of vouches that each category of endorsers have provided to the applicant.

FIG. 8 is a schematic screenshot of an embodiment of the applicant's skills set, wherein the applicant and/or the hiring party may be able to view his or her list of skill sets as compiled using the endorsements or recommendations from the endorsers.

FIG. 9 is a schematic screenshot of an embodiment of the vouch request form sent by the applicant to the endorser, wherein the endorser may either accept or decline to provide his or her endorsement or recommendation accordingly.

FIG. 10 is a schematic screenshot of an embodiment of the applicant's education and work experience verification and validation form, wherein the endorser can confirm the education and work experience of the applicant.

### DETAIL DESCRIPTION OF THE INVENTION

The system and method of the invention disclosed herein is an innovative skill-based endorsement or recommendation system. More specifically, the system is a unique system that more readily allows job seekers (“applicants”) to supplement their professional profile with endorsements from classmates, professors, colleagues and managers (“endorser”) in an electronic form. In other words, the system allows applicants to request from endorsers for their support by vouching for the applicants.

More specifically, each endorser is required to peg each vouch with a set of distinct skills or personality traits that he or she considers the strong suit of the applicant. The endorser also has the option to write a brief statement expounding upon the suggested strengths of the endorsee. For example, the endorser may vouch for the applicant as being a team player who can work well in a team environment. In such a case, the endorser would be given an opportunity for him or her to give at least one reason he or she believes the applicant is a good team player, e.g. the endorser had previously collaborated or worked on a joint project with the applicant.

Furthermore, each endorser can also serve to verify or validate the degrees and work experiences of the applicant. For example, a professor would likely be more competent in verifying or validating whether the applicant has a specialization, certification, or degree in a certain area of study. An employer, on the other hand, would be more able to verify or validate the applicant's work experience. As such, endorsers would be prompted to verify and validate the applicant's education and work experience.

As the endorser provides or vouches for the other skills of the applicants, a list of skills will be generated by the system through the endorser's input. The list of skills compiled by the system will then be provided to the applicant in order of skill popularity. In other words, if more endorsers provide that the applicant is a team-player, but fewer endorsers provide that the applicant has strong communication skills, then the trait “team-player” will rank higher than the skill “strong communication skills” in the list. As such, this will allow the applicants to understand their strengths as well as relative weaknesses. Furthermore, these vouched-for skills will serve as validation of skills already established in the applicants profile as well as reveal a new set of skills they may have not known they have. In other words, the applicants may discover skills or talents that they never knew they had, and, thus, gain a better understanding of themselves in a professional setting.

As the endorsers verify and validate the education level and the work experience of the applicant, the information will be stored and reflected in the system. Therefore, upon identifying a potential applicant, the hiring party would be able to access the system to verify and validate the applicant's education and work experience as necessary. This is important because one major problem that exists in today's job market is that many resumes have some level of fraudulence, whether it be the claimed level of expertise for any particular skill, years worked at an organization, degree level, job title, etc. As such, this system and method will also provide an extra level of verification or validation of the applicant.

Similarly, the hiring party will be presented with the same list of skills, helping them validate the proclaimed skill set in the applicant's profile as well as learn more about the particular strengths of that applicant. From the list of skills, the hiring party would be able to select desired candidates from the applicant pool through indicating which skills from the list are more desirable than those of other skills. For example, a hiring party seeking a candidate for a secretarial position may find that an applicant's skill for being “organized” is far more important than an applicant's skill for being a “team-player.” As such, the hiring party can sort through the applicant pool through the use of the list of skills of applicants, thereby aiding the hiring party to hire a better qualified applicant for a particular employment position.

In one embodiment of the invention, the applicant has a section under his or her profile showing how many endorsements or recommendations that they have from each category of endorsers. These endorser categories may include, but is not limited to, classmates, professors, colleagues and managers. Under each category, the applicant can see the list of endorsers and their endorsements of the applicant. From such, the applicant would be able to gain a better understanding of his or her strength as well as relative weaknesses based on the vouches of the endorsers.

Initially, in order to obtain the endorsements or recommendations of the endorsers, the applicant must send a request to the endorsers. In sending these requests the system can automatically pre-populate a list of people suitable for being endorsers for the applicant in each category using the applicant's network information extrapolated from the user's Facebook, LinkedIn, or other similar social network accounts. The applicant can then manually add or remove recipients from the pre-populated list before sending the request.

In one embodiment, the present invention allows job seekers to send endorsement requests to connections across multiple social and professional networking platforms. Upon registration, the job seeker is prompted to import their connections from platforms such as Facebook, LinkedIn, Twitter and other social and professional networking sites in order to access a broadened endorser base. In the process of importation, the job seeker is asked by said social and professional networking platform if they ‘allow’ the present invention to access their network information, including their network's work history and education information. If the job seeker agrees, the present invention imports and aggregates all the job seeker user's network connections from each source, including their network's work history and education information.

Now, when the job seeker engages in the ‘send requests’ module in the process of sending endorsement requests, the present invention presents the job seeker an organized send list comprising of all their connections derived from their resulting aggregate network. Furthermore, when the job seeker chooses a specific category of endorser (i.e. classmate, professor, colleague, supervisor, or friend), the platform generates a category-specific send list comprising of endorsers from that particular category (e.g. if the user chooses the ‘classmates’ category, the system finds all their connections from their aggregate network that attended the same school as the job seeker). After specifying exactly to which endorsers they are sending the requests, the present invention then sends those requests directly to the recipient via the respective platform from which they are derived, whether it be Facebook, LinkedIn, Twitter or any other variety of social and professional network platform (e.g. if the job seeker sends an endorsement request to a classmate derived from the Facebook platform, that classmate receives the request directly on the Facebook platform, where they are then redirected to our site to fill out the ‘vouch request form.’ Once the endorser submits the ‘vouch request form,’ the job seeker user now sees the submitted endorsed skills in his/her profile and is able to view exactly whom endorsed that particular skill (e.g. if the endorser endorsed the job seeker's Analytical skill, the job seeker is able to see the name of that particular endorser).

Then, when the recipient has received the request, they have two options: (1) Yes, I do vouch for this individual or (2) No, I do not vouch for this individual. The endorsers can decline to recommend the individual for a variety of reasons, whether personal or professional. Upon declining to provide their recommendation or endorsement of the individual, they are required to choose from a brief list of reasons for why they do not vouch for that individual—i.e. “I don't know this person well enough.”Alternatively, the endorser can choose to accept the request and endorse the applicant.

In one embodiment, upon choosing to endorse the individual, the endorsers are prompted to choose up to ten skills and personality traits that the endorser considers the strong suit of that particular individual—i.e. a reason for why they vouch for that individual. In fulfilling this task, the endorser has two options—the endorser can either vouch for new skills or personality traits or the endorsers can vouch for relevant skills. In vouching for new skills or personality traits, the endorser can vouch for any skill or trait he or she wishes by typing into a hybrid field/dropdown menu, which is prepopulated with hard skills, soft skills and personality traits. On the other hand, in vouching for relevant skills, the endorser can choose from a system-generated, predetermined list of skills and traits, which is derived from three sources: A) Skills the applicant has claimed in their professional profile B) Skills that have been most frequently vouched for by other endorsers and C) A set of skills generated by our system that are relevant to the applicant's specific education and employment history (e.g. for a computer science major, the system would suggest skills like ‘CSS,’ ‘HTML,’ ‘Object oriented programming,’ ‘technologically savvy,’ etc.). Once the endorser has vouched for up to ten skills and/or personality traits, he or she also has the option to write a brief statement expounding upon the reason they chose any of the chosen skills or strengths. Finally, the endorser is prompted by the system to provide his or her name and to provide information regarding at which school or company he or she had worked with the endorsee. The system will know whether to ask for the school or company based on what the endorser category the applicant indicated on the send request form.

Upon receiving the endorsement or recommendations from the endorsers, the vouches will be stored in the database of the system. From there, the applicant can access his or her account and view his or her vouches from the endorsers. The applicant will be presented with a list of skills compiled from the complete vouches from his or her endorsers. Theses compiled skills are ranked in order of vouch frequency (e.g. “9 professors said you have strong presentation skills,” “7 professors said you have strong Microsoft Excel skills,” etc.). This will allow the applicant to be able to self-evaluate his or her relative strength and weaknesses, thus providing the applicant with a better understanding of him or herself.

Furthermore, the hiring parties can also view the same list of skills from the applicant's endorsers. Hiring parties can use the compiled list of skills in the assessment process of that candidate. By matching the desired-for skills for a particular employment position with the skills of the applicants, the hiring parties can better find a more suitable applicant for the available position.

In another aspect of the invention, a system to host an interaction platform for users comprising a network; a host computer; wherein the host computer is connected to the network wherein the host computer provides a job placement platform for one or more users to interact for the purpose of job placement wherein the users are comprised of at least one job seeking user, at least one job provider user, and at least one third party credential validation provider, a credential validation module allowing the job seeking user to request credential validation from the third party credential validation provider and allowing the third party credential validation provider to provide a credential validation to the job seeking user, a viewing module wherein the job provider user can view the job seeking user's credential validation in deciding whether to hire the job seeker. In one embodiment the job placement platform is further comprised of an analytical module wherein the module analyzes data comprising the job seeking user activities, the job provider user activities and the third party credential validation provider activities.

In one embodiment, the job seeking user initiates further credential validation request based on data analysis of the analytical module. In one embodiment the job seeking user can select which job provider can view the job seeking credential validation.

In another aspect of the invention, the system is capable of hosting an interaction platform for users comprising a network; a host computer; wherein the host computer is connected to the network wherein the host computer provides a job placement platform for one or more users to interact for the purpose of job placement wherein the users are comprised of at least one job seeking user, at least one job provider user, and at least one third party credential validation provider, a credential validation module allowing the job seeking user to request credential validation from the third party credential validation provider and allowing the third party credential validation provider to provide a credential validation to the job seeking user, a viewing module wherein the job provider user can view the job seeking user's credential validation in deciding whether to hire the job seeker.

So similar to the third party skill-based endorsement request, the validation request is sent out to a validation provider for validation. Typical credential validation includes credential such as degrees, educational backgrounds, certificates, memberships and or awards.

In one embodiment the job placement platform is further comprised of an analytical module wherein the module analyzes data comprising the job seeking user activities, the job provider user activities and the third party credential validation provider activities. In one embodiment, the job seeking user initiates further credential validation request based on data analysis of the analytical module. In one embodiment the job seeking user can select which job provider can view the job seeking credential validation.

In one embodiment the skill a credential validation module is further comprised of a validation relevancy module wherein the validation relevancy module generates a recommended list of credential validation requests third party credential validation provider based on the profile of the job seeking user. In one embodiment, the credential validation module is further comprised of a validation relevancy module wherein the validation relevancy module generates a recommended list of credential validation requests to the third party credential validation provider based on the credential of the Job seeking user and said credential's nexus to the third party credential validation provider. In another embodiment, the credential is comprised both academic and professional credentials. So for example, the validation relevancy module detects in the profile of the job seeking user which has the job seeking user's credentials showing education degrees and it detects the connection of the third party credential validation provider as student and professor, it then prompts to send credential validation request to validate the job seeker's degree. In another example, the validation relevancy module detects the association of the third party credential validation provider to the job seeker as “committee to member”, it then prompts to send credential validation request to validate the job seeker's to membership credential.

### DETAILED DESCRIPTIONS OF THE DRAWINGS

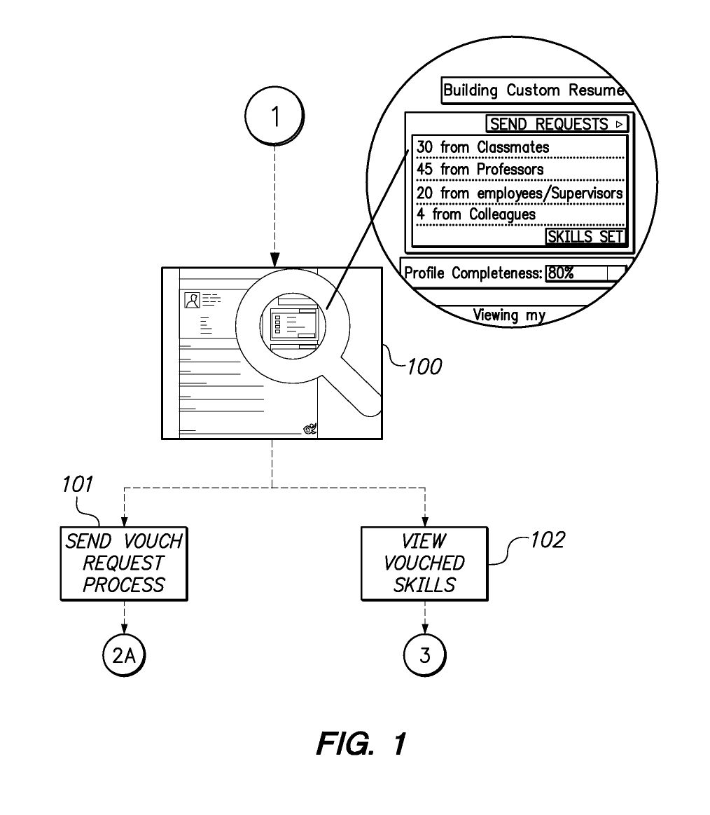

FIG. 1 is a flowchart diagram of the skill-based endorsement system process, wherein the job seeker, or endorsee, may log into the system to view his or her profile 100. Via his or her profile 100, the endorsee can, through the system, either send “Vouch Requests” 101 or view “Vouched Skills” 102 acquired from responses of endorsers from previous vouch requests.

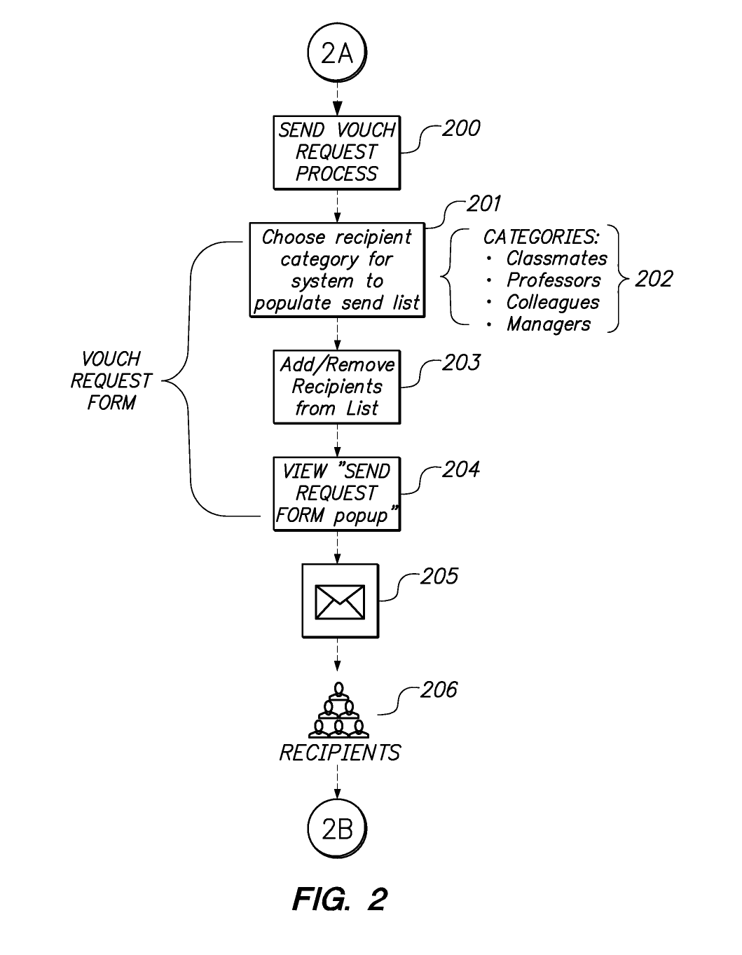

In FIG. 2, upon selecting the “Vouch Request,” 200 the endorsee will then chooses a recipient category 201 for the system to populate a send list, wherein the categories can be from classmates, professors, colleagues, managers, etc. 202. In one embodiment, the system automatically populate a “Send List” 203 for each category using the endorsee's network information extrapolated from a variety of available sources, such as Facebook or LinkedIn accounts, among others wherein the endorsee is then able to manually add or remove recipients from the “Send List” 203. Specifically, the present invention allows job seekers to send endorsement requests to connections across multiple social and professional networking platforms. Upon registration, the job seeker is prompted to import their connections from platforms such as Facebook, LinkedIn, Twitter and other social and professional networking sites in order to access a broadened endorser base. In the process of importation, the job seeker is asked by said social and professional networking platform if they ‘allow’ the present invention to access their network information, including their network's work history and education information. If the job seeker agrees, the present invention imports and aggregates all the job seeker user's network connections from each source, including their network's work history and education information.

Upon selecting the desirable individuals for the “Send List” 203, the endorsee will be prompted by the system to review the “Send Request Form” 204, wherein the endorsee can include a message to those individuals on the “Send List” 203 in order to obtain the desired endorsements. Upon the endorsee's satisfaction and approval, the “Vouch Request” 200 will be sent out via email or other means of electronic communication 205 to the intended recipients 206, i.e. individuals on the “Send List” 203.

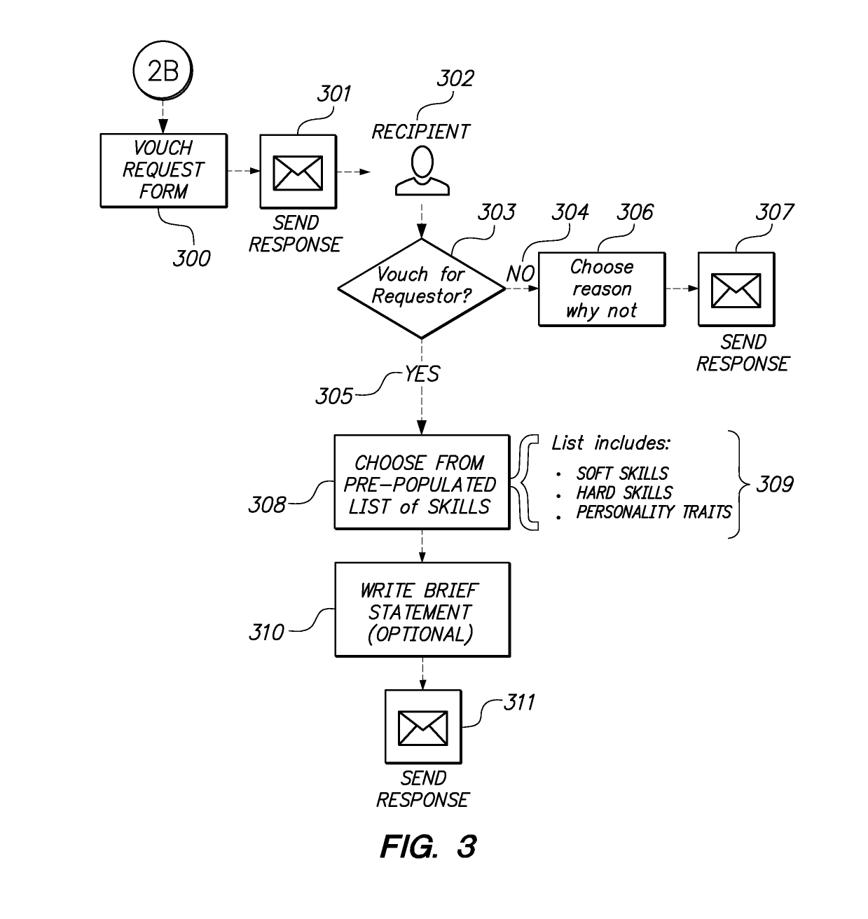

In FIG. 3, upon receiving the “Vouch Request” 300, via email or other means of electronic communication 301 from the endorsee, the recipients 302 have two options 303: to either choose not to provide his or her endorsement 304 or choose to provide his or her endorsement 305 of the endorsee. If a recipient 302 decides not provide his or her endorsement 304, the recipient 302 is prompted by the system to provide at least one reason explaining why they do not endorse that individual 306, e.g. “I do not know this person well enough.” Upon such selection to provide a reason for declining to endorse 306, the recipient 302 can send his or her response 307 to the endorsee, wherein the endorsee can know why he or she did not receive the endorsement of a particular individual 302.

If a recipient 302 decides to provide his or her endorsement 305, the recipient or endorsee 302, can then choose from a pre-populated list 308 of soft skills, hard skills, or personality traits that he or she considers to be the strong suit of the endorsee 309, i.e. a reason for why they vouch for that individual. Furthermore, the endorser 302 is also given the option of providing a brief written statement 310 regarding the endorsee. In another embodiment, the endorser 302 can also give a brief written statement 310 as to why he vouched for a specific skill or trait for the endorsee. To the satisfaction and approval of the endorser 302, the list of skills 309 and the written statement 310, if any, are then sent back 311 to the endorsee.

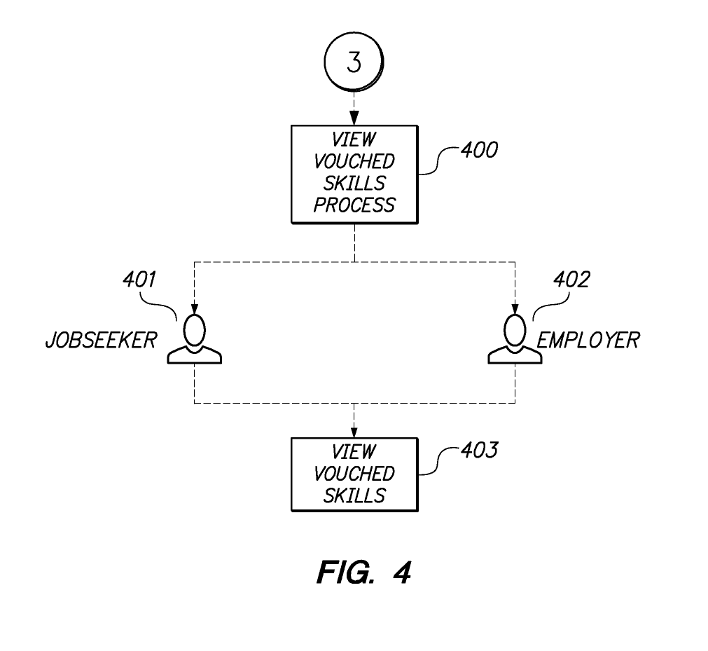

In FIG. 4, the system keeps a record 400 of all the endorsements the endorsee received from the endorsers via “Vouch Requests” that were sent out, wherein the endorsee 401 and potential employer 402 can both view 403 the endorsee's list of vouched skills and endorsements in its assessment of the candidate.

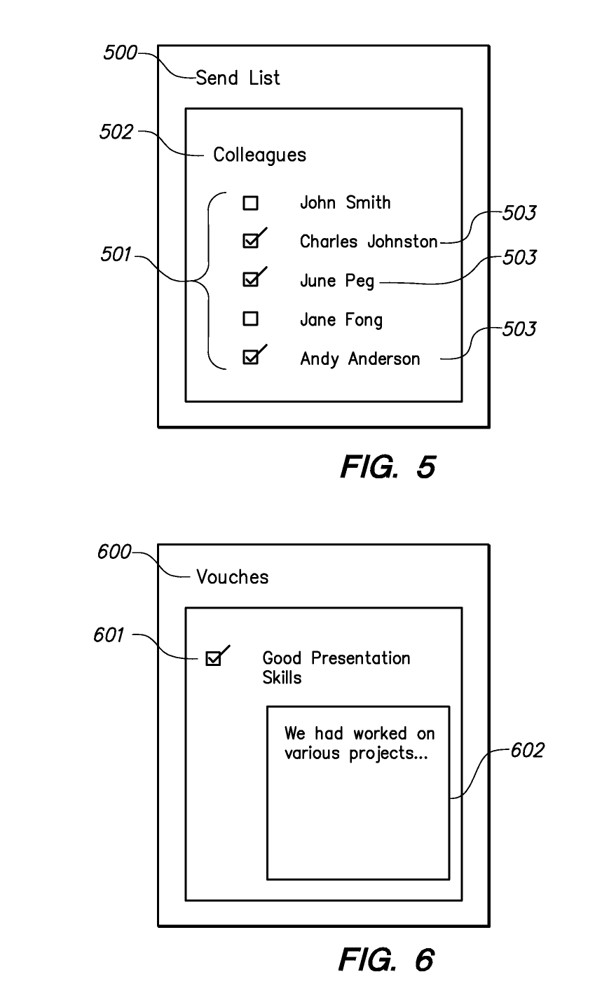

In FIG. 5 the “send list” 500 is a list 501 that is pre-populated with the personal information that is extrapolated from the applicant's social network such as Facebook, LinkedIn, or other similar accounts. The send list 501 is comprised of various categories, such as classmates, professors, managers and colleagues 502. Furthermore, under each category, there is a list of individuals 501 that may serve as an endorser who may endorse or recommend for the applicant. The applicant will be given a choice to manually select 503 which individuals from the list 501 would serve to be his or her endorser.

FIG. 6 is a schematic screenshot of an embodiment of the endorser's vouches form 600, wherein the endorser can select from a list of hard skills, soft skills, or personality traits. For example, in this embodiment, the endorser selected, among others, that the applicant has “good presentation skills” 601. Upon selection of a hard skill, soft skill, or personality trait, the endorser may, upon his or her choosing, provide a written description 602 to support his or her reasoning for selecting the skills set that he or she believes the applicant has.

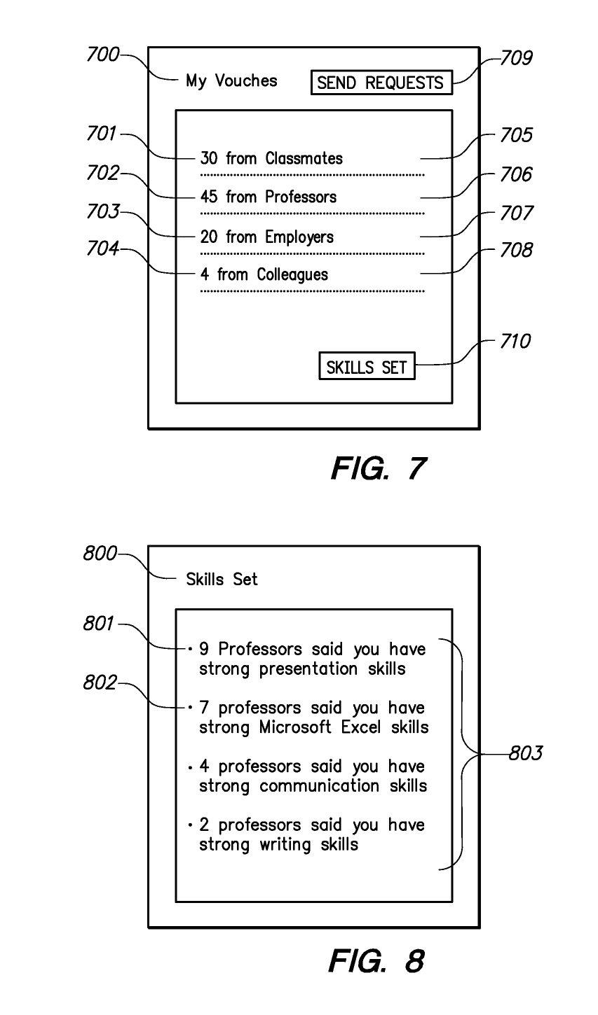

FIG. 7 is a schematic screenshot of an embodiment of the applicant's vouches 700, wherein the applicant can view the number of vouches 701, 702, 703, 704 that each category of endorsers 705, 706, 707, 708 have provided to the applicant. If the applicant feels that the number of vouches 701, 702, 703, 704 from certain categories of endorsers 705, 706, 707, 708 is lacking, the applicant may click on the “send requests” button to send more requests in a given category. For example, here, the applicant only has 4 vouches 704 in the “colleagues” category 708. Therefore, the applicant may wish to use send requests 709 to other colleagues in order to get more endorsements or recommendations. If, on the other hand, the applicant is satisfied with the number of vouches 701, 702, 703, 704 from each categories of endorsers 705, 706, 707, 708, then the applicant can go on to view his skills sets 710.

FIG. 8 is a schematic screenshot of an embodiment of the applicant's skills set. Upon selecting to view his or her skills set 800, the applicant will be given a list of skills in order of the skills more frequently mentioned to those less frequently mentioned by the endorsers. For example, the first skill listed with nine professors stating that that applicant has strong presentation skills 801 is the most often mentioned skill by the applicant's endorser, and as such, it is the first on the list. Then, the second skill listed shows that seven professors stated that the applicant has strong Microsoft Excel skills 802. This would indicate that of those skills vouched for the applicant, it is the second most mentioned strength of the applicant, etc. Both the applicant and/or the hiring party may be able to view the applicant's list of skills 803 as compiled using the endorsements or recommendations from the endorsers.

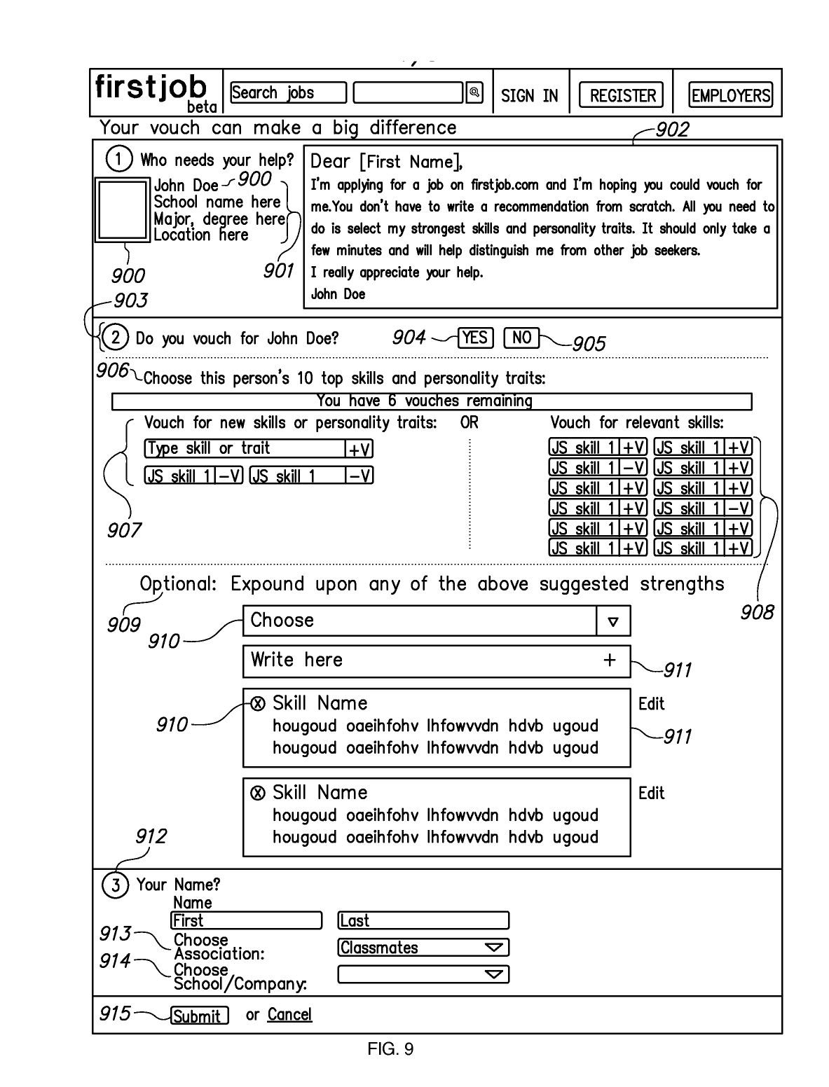

FIG. 9 is a schematic screenshot of an embodiment of the vouch request form sent by the applicant to the endorser. The vouch request form will identify the applicant 900 and provide his or her basic information 901, such as company, school, major, degree, location, etc. The vouch request form will also include a message 902 from the applicant to the endorser, wherein the applicant explains the reason and requests for the endorsement or recommendation of the endorser. Next, the endorser is given an option 903 to accept 904 or decline 905 to provide endorsement or recommendation of the applicant. Upon declining 905 to provide the requested endorsement or recommendation, the endorser will be prompted to provide his or her reason for declining. Upon accepting 904 to provide the requested endorsement or recommendation, the endorser will be prompted to choose from a list of up to ten skills and personality traits 906 of the applicant. The endorser can either vouch for new skills or personality traits 907 or vouch for relevant skills 908 of the applicant. In one embodiment, in vouching for new skills or personality traits 907, the endorser can vouch for any skill or trait they have by typing into an input form wherein these skills or traits can be categorized under a) hard skill, b) soft skill, and c) personality trait. In another embodiment, in vouching for relevant skills 908, the endorser can choose from a system-generated, predetermined list of skills and traits, which are derived from three sources: a) Skills the applicant has claimed in his or her professional profile, b) Skills that have been most frequently vouched for by other endorsers and c) A set of skills generated by our system that are relevant to the applicant's specific education and employment history (e.g. for a computer science major, the system would suggest skills like ‘CSS,’ ‘HTML,’ ‘Object oriented programming,’ ‘technologically savvy,’ etc.). Finally, upon vouching up to ten skills and/or personality traits, the endorser has the option 909 to expound upon any of the suggested strengths. The endorsers can choose any of the chosen skills/strengths in the previous step 910 and give a brief explanation 911. The system also prompts the endorser to provide his or her name 912, association 913 and school or company 914. Upon completion of the form, the endorser can then submit 915 the vouch request form.

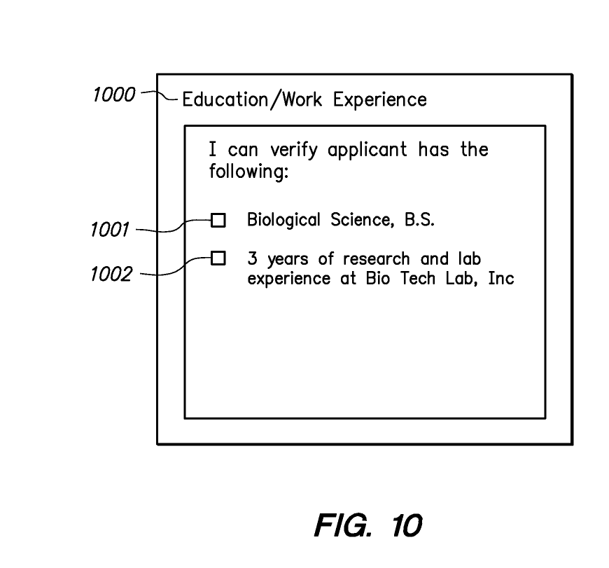

FIG. 10 is a schematic screenshot of another embodiment of the vouch system which includes a validation request form wherein in the education and work experience form 1000, a the list of education level 1001 and work experience 1002 as indicated by the applicant is presented to the endorser for validation. The endorser then will have the ability to verify and validate that education 1001 or work experience 1002 as appropriate and as necessary. Similar to the endorsements, the validations can be viewed by other users. In one embodiment, the validation request form will identify the applicant's school, major, degree, location, etc. The validation request form will also include a message from the applicant to the endorser, wherein the applicant explains the reason and requests for validation of the endorser. Next, the endorser is given an option to accept or decline to provide validation to the applicant. Upon declining to provide the requested validation, the endorser will be prompted to provide his or her reason for declining. Upon completion of the form, the endorser can then submit the validation request form.

FIG. 10 is a schematic screenshot of another embodiment of the vouch system which includes a validation module wherein in the education and work experience form 1000, a the list of education level 1001 and work experience 1002 as indicated by the applicant is presented to the endorser for validation. The endorser then will have the ability to verify and validate that education 1001 or work experience 1002 as appropriate and as necessary. Similar to the endorsements, the validations can be viewed by other users.

The claimed subject matter has been provided here in specific details with reference to one or more features or embodiments. It is appreciated that changes and modifications may be applied to said embodiments without limiting or departing from the generally intended scope. These and various other adaptations and combinations of said embodiments are within the scope of the disclosed subject matter as defined by the claims and their full set of equivalents.

1. A system to host an interaction platform for users comprising a network; a host computer; wherein said host computer is connected to said network wherein said host computer provides a job placement platform for one or more users to interact for the purpose of job placement wherein said users are comprised of at least one job seeking user, at least one job provider user, and at least one third party skill-based endorsement provider, a skill endorsement request module allowing said job seeking user to request skill-based endorsement from said third party skill-based endorsement provider and allowing said third party skill-based endorsement provider to provide a skill-based endorsement to said job seeking user, a viewing module wherein said job provider user can view said job seeking user's skill-based endorsements in deciding whether to hire said job seeker wherein said job placement platform is further comprised of an analytical module wherein said analytical module categorizes said third party skill-based endorsement provider into one or more classes based on said third party skill-based endorsement provider's relationship to said job seeking user and quantify the number of endorsements of said job seeking user received from said one or more classes wherein said analytical module further provides for viewing by displaying a frame showing said quantity of endorsements received from said one or more classes wherein said job seeking user initiates further skill-based endorsement request based on viewing said frame.

2. A system to host an interaction platform for users comprising a network; a host computer; wherein said host computer is connected to said network wherein said host computer provides a job placement platform for one or more users to interact for the purpose of job placement wherein said users are comprised of at least one job seeking user, at least one job provider user, and at least one third party skill-based endorsement provider, a skill endorsement request module allowing said job seeking user to request skill-based endorsement from said third party skill-based endorsement provider and allowing said third party skill-based endorsement provider to provide a skill-based endorsement to said job seeking user, a viewing module wherein said job provider user can view said job seeking user's skill-based endorsements in deciding whether to hire said job seeker wherein said job placement platform is further comprised of an analytical module wherein said analytical module categorizes said third party skill-based endorsement provider into one or more relationship classes based on said third party skill-based endorsement provider's relationship to said job seeking user; and categorizes said skill-based endorsement into one or more skill classes based on the skill type of said skill-based endorsement; and quantify the number of endorsements of said job seeking user received from said one or more relationship classes and said one or more skill classes wherein said analytical module further provides for viewing by displaying a frame showing said quantity of endorsements received from said one or more relationship classes and said skill classes wherein said job seeking user initiates further skill-based endorsement request based on viewing said frame.

3. (canceled)

4. System of claim 1 wherein said job seeking user can select which job provider can view said job seeking user's skill-based endorsement.

5. System of claim 1 wherein said job seeking user's skill-based endorsement is available only to specific users for viewing wherein said specific user is determined by said third party skill-based endorsement provider.

6. The system of claim 1 wherein said skill endorsement request module is further comprised of a validation module wherein said validation module allows said job seeking user to request a credential validation from said third party skill-based endorsement provider and allowing said third party skill-based endorsement provider to provide said credential validation to said job seeking user wherein said viewing module allows said job provider user to view said job seeking user's credential validation in deciding whether to hire said job seeker.

7. The system of claim 6 wherein said credential validation module is further comprised of a validation relevancy module wherein said validation relevancy module generates a recommended list of credential validation requests to said third-party skill-based endorsement provider based on the credential of said Job seeking user and said credential's nexus to said third-party skill-based endorsement provider.

8. The System of claim 7 wherein said credential is comprised both academic and professional credentials.

9-14. (canceled)
